(19) United States
(12) Patent Application Publication
(10) Pub. No.: US 2014/0215874 A1
(43) Pub. Date: Aug. 7, 2014

(54) Easily-Attachable Tree Sign

(71) Applicant: Timothy BASHORE, Eugene, MO (US)

(72) Inventor: Timothy BASHORE, Eugene, MO (US)

(21) Appl. No.: 14/172,650

(22) Filed: Feb. 4, 2014

Related U.S. Application Data
(60) Provisional application No. 61/760,734, filed on Feb. 5, 2013.

(51) Int. Cl. G09F 7/18

(52) U.S. Cl. CPC G09F 7/18
USPC 40/607.14

(57) ABSTRACT

An easily-attachable tree sign is an apparatus that can be mounted on the trunk of a tree or any other cylindrical object. The apparatus includes a flexible sheet, a pair of channels, a pair of straps, and a printed graphic. The printed graphic is positioned across the flexible sheet that is used to brace the cylindrical surface of an object. The two channels are positioned opposite of each other across the flexible sheet, which prevents the flexible sheet from wrinkling once the pair of straps attaches the apparatus to a cylindrical object. Each strap traverses through its respective channel so that each strap can support opposing sections of the flexible sheet. Each strap also has a first end and a second end that can either be tied together or clasped to each other by a fastener.

The current application claims a priority to the U.S. Provisional Patent application Ser. No. 61/760,734 filed on Feb. 5, 2013.

### FIELD OF THE INVENTION

The present invention relates generally to notification signs. More specifically, the present invention is a flexible sign featuring integrated channels for accommodating straps with which the sign is attached to a cylindrical surface.

### BACKGROUND OF THE INVENTION

Notification signs serve a wide variety of purposes and are posted in many locations. Signs are mounted to notify passerby of private property boundaries and the ramifications of intrusion. This is particularly notable in the case of large properties that often require many signs interspersed along the perimeter of the properties. Signs may also alert passerby to the presence of an animal on the property, such as a large dog. Employment opportunities are often placed on signs mounted in well traveled locations as well. Additionally, signs are often posted to inform the public of events such as garage sales and open houses. These types of notification signs are typically mounted to roughly cylindrical objects such as trees and poles. The mechanism of attachment commonly utilized generally encompasses the use of fasteners that are impaled through the sign and into the mounting surface. This attachment mechanism often results in the mounting surface becoming damaged. Continuous use of fasteners such as nails on trees can result in stripped bark and/or other forms of damage. Additionally, signs are subject to wear and tear brought upon by exposure to the elements and become unreadable and ineffective after extended periods of time. The present invention seeks to provide an improved durable sign that may be conveniently mounted without causing damage to the mounting surface.

The present invention is a flexible sign with a plurality of integrated channels for accommodating straps that are used to tie the sign to a cylindrical surface. In its preferred embodiment, the present invention comprises a sign formed from a flat piece of material composed of layered nylon and linear low-density polyethylene (LLDPE). Alternative embodiments of the present invention may incorporate additional unspecified materials in manufacturing the sign. The sign has a top edge, a bottom edge, a left edge, and a right edge. The top edge and bottom edge of the sign are folded a short distance back onto the surface of the sign and the layered material is processed through a sealing machine. The top edge and bottom edge are heat sealed to the surface of the sign in order to form a top channel and a bottom channel. The top channel and bottom channel both extend from the left edge to the right edge. The sign is designed for attachment to a cylindrical surface such as that of a tree or a pole. A thin polyethylene strap is inserted into both the top channel and the bottom channel. The polyethylene straps are wrapped around the cylindrical mounting surface and tied end to end to secure the sign to the surface.

The present invention provides an improved form of sign that may be mounted without the use of damaging fasteners. The use of a material such as LLDPE is ideal as LLDPE displays characteristics that are particularly well-suited for outdoor signs. The material of the present invention is durable and resilient against damage caused by impacts and stretching as LLDPE is generally puncture resistant as well as flexible. Outdoor signs are constantly exposed to sunlight, causing the signs to fade and become discolored. Heat generated by sunlight degrades outdoor signs and causes the material to lose its physical properties. The present invention is not subject to the adverse effects of ultraviolet exposure as LLDPE is resistant to ultraviolet exposure. Additionally, LLDPE is generally resilient in environments of both extreme heat and extreme cold.

### BRIEF DESCRIPTION OF THE DRAWINGS

FIG. 1 is a perspective view of the present invention.

FIG. 2 is a perspective view showing the internal configuration of the present invention.

FIG. 3 is a perspective view of the present invention without the top strap and the bottom strap.

FIG. 4 is a side view of the present invention without the top strap and the bottom strap.

FIG. 5 is a front perspective view of the present invention being attached to a cylindrical object.

FIG. 6 is rear perspective view of the present invention being attached to a cylindrical object, wherein the first end and the second end of each strap is tied together.

FIG. 7 is a rear perspective view of the present invention being attached to a cylindrical object, wherein the first end and the second end of each strap is clasped together by a fastener.

### DETAILED DESCRIPTIONS OF THE INVENTION

All illustrations of the drawings are for the purpose of describing selected versions of the present invention and are not intended to limit the scope of the present invention.

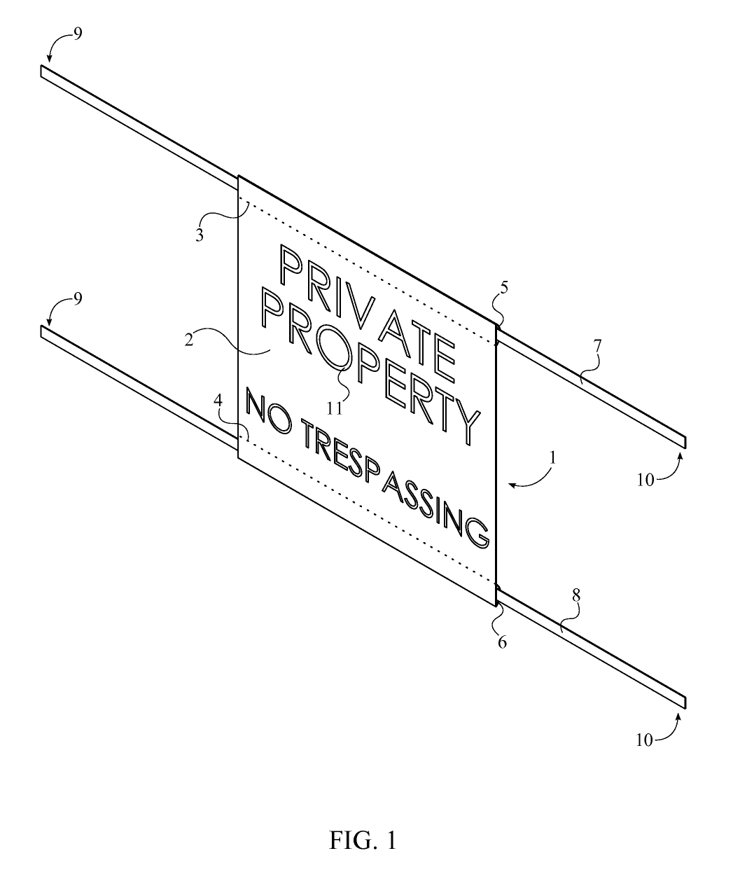

As can be seen in FIG. 1, the present invention is a sign that can be easily attached to the trunk of a tree or any other cylindrical object. The present invention comprises a flexible sheet 1, a top flexible tubing 5, a bottom flexible tubing 6, a top strap 7, a bottom strap 8, and a printed graphic 11. The flexible sheet 1 is the main body of the present invention and allows the other of components of the present invention to be connected together. The printed graphic 11 is used to display the pertinent content of the present invention. The top strap 7 and the bottom strap 8 allow the present invention to be attached to the trunk of a tree or any other cylindrical object by wrapping around its cylindrical surface. The top flexible tubing 5 and the bottom flexible tubing 6 are respectively used to support the flexible sheet 1 with both the top strap 7 and the bottom strap 8.

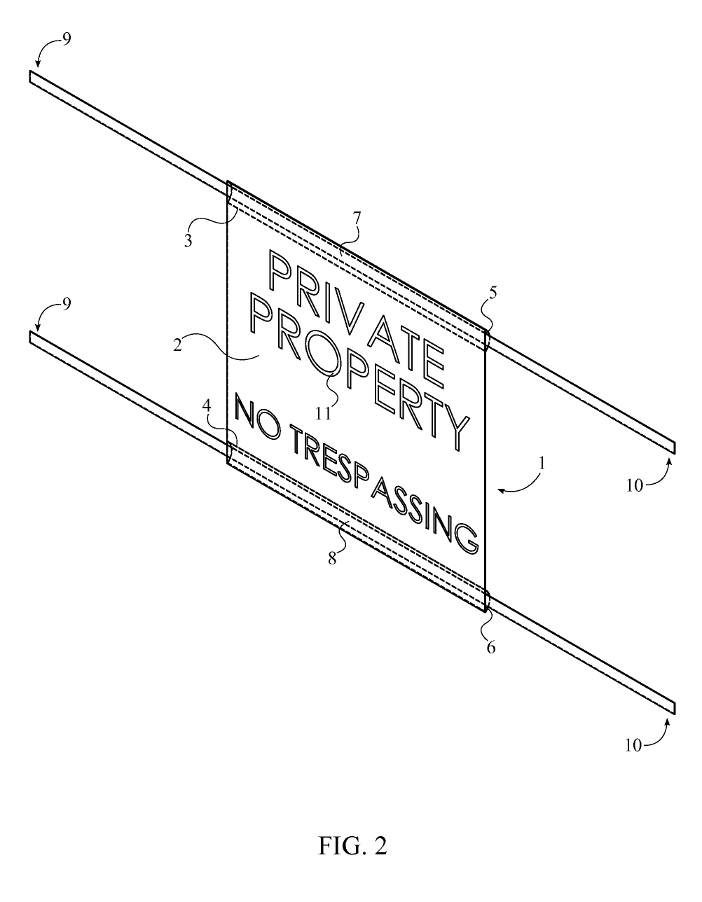

The general configuration of its components allows the present invention to be attached to the trunk of a tree without difficulty and is shown in FIG. 2. The printed graphic 11 is positioned across the flexible sheet 1 so that passersby can view the printed graphic 11 as the present invention is attached to the trunk of a tree. Moreover, the top flexible tubing 5 is adjacently connected to the flexible sheet 1, and the bottom flexible tubing 6 is adjacently connected to the flexible sheet 1 opposite to the top flexible tubing 5 so that the top flexible tubing 5 and the bottom flexible tubing 6 can evenly and vertically stretch the flexible sheet 1. This prevents any wrinkles within the flexible sheet 1 that could compromise the discernability of the printed graphic 11. In addition, the top strap 7 is positioned through the top flexible tubing 5 so that the top strap 7 is slidably engaged through the top flexible tubing 5. This allows the ends of the top strap 7 to be adjustable attached together. Similarly, the bottom strap 8 is positioned through the bottom flexible tubing 6 so that the bottom strap 8 is slidably engaged through the bottom flexible tubing 6. Again, this allows the ends of the bottom strap 8 to be adjustable attached together.

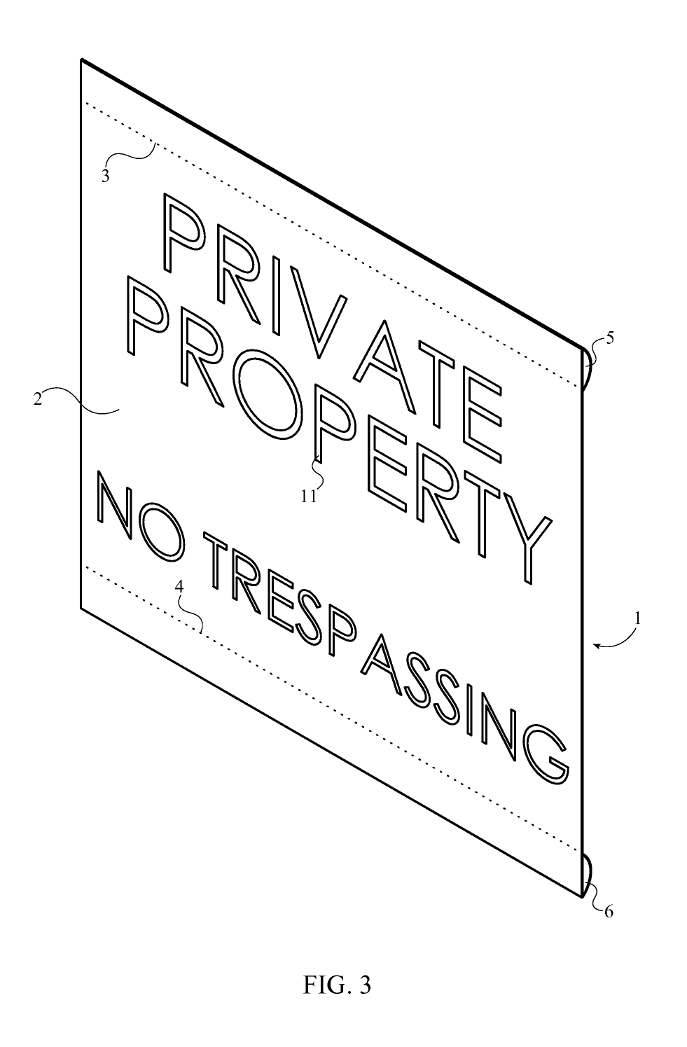

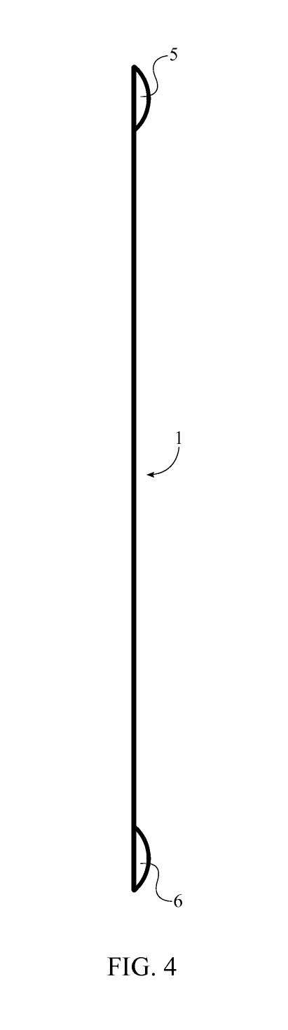

As can be seen in FIG. 3, the flexible sheet 1 has a specific configuration in order to properly orient the printed graphic 11. The flexible sheet 1 comprises a graphic displaying portion 2, a top edge 3, and a bottom edge 4. The graphic display portion allows the flexible sheet 1 to support and orient the printed graphic 11. In the preferred embodiment of the present invention, the printed graphic 11 is embedded upon the graphic display portion, which is a flat portion of the flexible sheet 1. In an alternate embodiment of the present invention, the printed graphic 11 is a decorated sheet, and the graphic displaying portion 2 is a sealable pocket integrated into the flexible sheet 1 so that the decorated sheet can be inserted into the sealable pocket. The graphic displaying portion 2 is located in between the top edge 3 and the bottom edge 4 of the flexible sheet 1. More specifically, the top flexible tubing 5 is connected along the top edge 3 of the flexible sheet 1, and the bottom flexible tubing 6 is connected along the bottom edge 4 of the flexible sheet 1, which allows the top flexible tubing 5 and the bottom flexible tube 6 to be parallel with each other. Consequently, this configuration prevents the top flexible tubing 5 and the bottom flexible tube 6 from obstructing the graphic displaying portion 2, which is illustrated in FIG. 4. Also in the preferred embodiment, the flexible sheet 1, top flexible tubing 5, and the bottom flexible tube 6 are made of a single sheet of flexible layer nylon and linear low-density polyethylene (LLDPE).

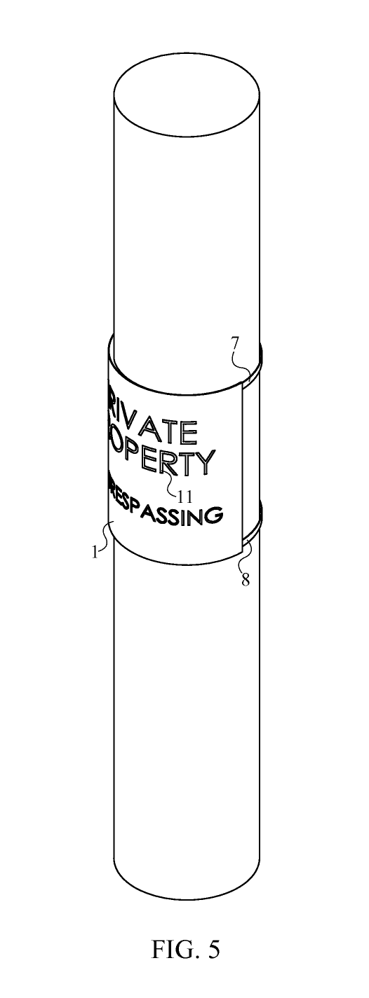

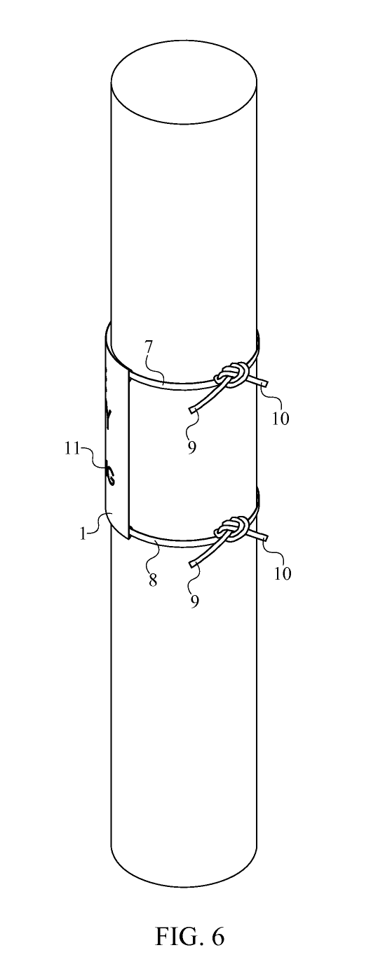

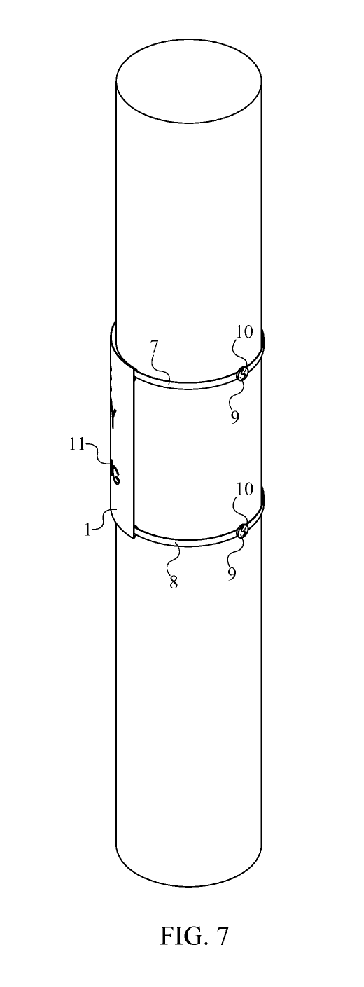

As can be seen in FIG. 5, the top strap 7 and the bottom strap 8 are used to hold the flexible sheet 1 in place as the present invention wraps around the trunk of a tree. The top strap 7 and the bottom strap 8 each comprise a first end 9 and a second end 10, which are positioned opposite to each other along their respective strap. The first end 9 and the second end 10 of the top strap 7 to be located outside of the top flexible tubing 5 so that the first end 9 can be attached to the second end 10 in order to form a loop with the top strap 7. Similarly, the first end 9 and the second end 10 of the bottom strap 8 to be located outside of the bottom flexible tubing 6 so that the first end 9 can be attached to the second end 10 in order to form a loop with the bottom strap 8. The loops formed by the top strap 7 and the bottom strap 8 can be used to attach the present invention around the trunk of a tree or any other cylindrical object. As can be seen in FIG. 6, one way to attach the first end 9 to the second end 10 is to tie the first end 9 to the second end 10 in order to form the loop with their respective strap. As can be seen in FIG. 7, another way to attach the first end 9 to the second end 10 is to clasps the first end 9 to the second end 10 in order to form the loop with their respective strap. In the preferred embodiment of the present invention, the top strap 7 and the bottom strap 8 are made of two strips of flexible layer nylon and linear low-density polyethylene (LLDPE).

The use of LLDPE as a principal material offers many benefits particularly in the case of outdoor signs. As a flexible material, LLDPE has the ability to greatly elongate under stress without compromising the integrity of the material. This is beneficial as outdoor signs are subject to winds that may tightly stretch the material of the signs. Another important characteristic of LLDPE is the resistance to ultraviolet exposure. Outdoor signs are constantly exposed to sunlight and are prone to fading and discoloration. Heat generated by ultraviolet light degrades materials over time and causes the materials to lose their physical properties. In addition to displaying resistance to ultraviolet exposure, LLDPE is generally not subject to adverse effects brought upon by environments of both extreme heat and extreme cold. A final integral characteristic of LLDPE is resistance to puncturing and tearing. As the present invention is intended for use outdoors, LLDPE provides the best balance between cost-effectiveness and durability/resilience in an outdoor setting. However, the present invention is not limited with respect to material of the sign and alternative embodiments of the present invention may utilize various other materials.

In the preferred embodiment of the present invention, the flexible sheet 1, the top flexible tubing 5, and the bottom flexible tubing 6 is made of a single sheet of material, which has a top extremity, a bottom extremity, a left extremity, and a right extremity. The top extremity and bottom extremity of the single sheet are folded a short distance back onto the surface of the single sheet. The folded top extremity and the folded bottom extremity both extend the entire length from the left extremity of the single sheet to the right extremity of the single sheet. The single sheet is then processed through an automatic sealing machine. The folded top extremity and the folded bottom extremity are heat sealed by a continuous band sealer. The continuous band sealer processes the single sheet on a moving conveyor belt over heating elements. The sealing process creates a top channel and a bottom channel that both extend from the left extremity of the sign to the right extremity. The top channel and the bottom channel are used as the top flexible tubing 5 and the bottom flexible tubing 6.

The present invention has a wide variety of applications as the sign may be mounted on virtually any cylindrical surface. The present invention may be attached to trees in order to clearly display the boundary lines of a private property. Additional signs may be used to warn trespassers of the presence of an animal on the property, such as a large dog. Signs with employment opportunities are often placed in well traveled locations. Finally, the present invention may be used to notify the public of events such as garage sales and open houses.

In one embodiment, the present invention has specific dimensions for specific components. The flexible sheet 1, the top flexible tube 5, and the bottom flexible tube 6 form a square section that is 9 inches by 9 inches. If the flexible sheet 1, the top flexible tube 5, and the bottom flexible tube 6 are manufactured from a single sheet of material, then the single sheet would need to be 12 inches by 12 inches. The top flexible tube 5 and the bottom flexible tube 6 are each 1.5 inches in width, and the top strap 7 and the bottom strap 8 are each 1 inch in width.

Although the invention has been explained in relation to its preferred embodiment, it is to be understood that many other possible modifications and variations can be made without departing from the spirit and scope of the invention as hereinafter claimed.

What is claimed is:

1. An easily-attachable tree sign comprises:
a flexible sheet;
a top flexible tubing;
a bottom flexible tubing;
a top strap;
a bottom strap;
a printed graphic;
said top flexible tubing being adjacently connected to said flexible sheet;
said bottom flexible tubing being adjacently connected to said flexible sheet opposite to said top flexible tubing;
said printed graphic being positioned across said flexible sheet;
said top strap being positioned through said top flexible tubing;
said top strap being slidably engaged through said top flexible tubing;
said bottom strap being positioned through said bottom flexible tubing; and
said bottom strap being slidably engaged said bottom flexible tubing.

2. The easily-attachable tree sign as claimed in claim 1 comprises:
said flexible sheet comprises a graphic displaying portion, a top edge, and a bottom edge;
said graphic displaying portion being located in between said top edge and said bottom edge;
said top flexible tubing being connected along said top edge;
said bottom flexible tubing being connected along said bottom edge; and
said printed graphic being located across said graphic displaying portion.

3. The easily-attachable tree sign as claimed in claim 1 comprises:
said top flexible tubing and said bottom flexible tubing being positioned parallel to each other.

4. The easily-attachable tree sign as claimed in claim 1 comprises:
said top strap comprises a first end and a second end;
said first end and said second end being positioned opposite to each other along said top strap;
said first end and said second end being located outside of said top flexible tubing; and
said first end being attached to second end in order to form a loop with said top strap.

5. The easily-attachable tree sign as claimed in claim 3, wherein said first end is tied to said second end in order to form said loop with said top strap.

6. The easily-attachable tree sign as claimed in claim 3, wherein said first end is clasped to said second end by a fastener in order to form said loop with said top strap.

7. The easily-attachable tree sign as claimed in claim 1 comprises:
said bottom strap comprises a first end and a second end;
said first end and said second end being positioned opposite to each other along said bottom strap;
said first end and said second end being located outside of said bottom flexible tubing; and
said first end being attached to second end in order to form a loop with said bottom strap.

8. The easily-attachable tree sign as claimed in claim 6, wherein said first end is tied to said second end in order to form said loop with said bottom strap.

9. The easily-attachable tree sign as claimed in claim 6, wherein said first end is clasped to said second end by a fastener in order to form said loop with said bottom strap.

10. The easily-attachable tree sign as claimed in claim 1, wherein said flexible sheet, said top flexible tubing, and said bottom flexible tubing is made from a single sheet of flexible layer nylon and linear low-density polyethylene.

11. The easily-attachable tree sign as claimed in claim 1, wherein said top strap and said bottom strap is made of two strips of flexible layer nylon and linear low-density polyethylene.

12. An easily-attachable tree sign comprises:
a flexible sheet;
a top flexible tubing;
a bottom flexible tubing;
a top strap;
a bottom strap;
a printed graphic;
said flexible sheet comprises a graphic displaying portion, a top edge, and a bottom edge;
said top flexible tubing being adjacently connected to said flexible sheet;
said bottom flexible tubing being adjacently connected to said flexible sheet opposite to said top flexible tubing;
said printed graphic being positioned across said flexible sheet;
said top strap being positioned through said top flexible tubing;
said top strap being slidably engaged through said top flexible tubing;
said bottom strap being positioned through said bottom flexible tubing;
said bottom strap being slidably engaged said bottom flexible tubing;
said graphic displaying portion being located in between said top edge and said bottom edge;
said top flexible tubing being connected along said top edge;
said bottom flexible tubing being connected along said bottom edge;
said printed graphic being located across said graphic displaying portion; and
said top flexible tubing and said bottom flexible tubing being positioned parallel to each other.

13. The easily-attachable tree sign as claimed in claim 12 comprises:
said top strap comprises a first end and a second end;
said first end and said second end being positioned opposite to each other along said top strap;
said first end and said second end being located outside of said top flexible tubing; and
said first end being attached to second end in order to form a loop with said top strap.

14. The easily-attachable tree sign as claimed in claim 13, wherein said first end is tied to said second end in order to form said loop with said top strap.

15. The easily-attachable tree sign as claimed in claim 13, wherein said first end is clasped to said second end by a fastener in order to form said loop with said top strap.

16. The easily-attachable tree sign as claimed in claim 12 comprises:
said bottom strap comprises a first end and a second end;
said first end and said second end being positioned opposite to each other along said bottom strap;
said first end and said second end being located outside of said bottom flexible tubing; and
said first end being attached to second end in order to form a loop with said bottom strap.

17. The easily-attachable tree sign as claimed in claim 16, wherein said first end is tied to said second end in order to form said loop with said bottom strap.

18. The easily-attachable tree sign as claimed in claim 16, wherein said first end is clasped to said second end by a fastener in order to form said loop with said bottom strap.

19. The easily-attachable tree sign as claimed in claim 1, wherein said flexible sheet, said top flexible tubing, and said bottom flexible tubing is made from a single sheet of flexible layer nylon and linear low-density polyethylene.

20. The easily-attachable tree sign as claimed in claim 1, wherein said top strap and said bottom strap is made of two strips of flexible layer nylon and linear low-density polyethylene.
